(19) United States
(12) Patent Application Publication
(10) Pub. No.: US 2013/0026145 A1
(43) Pub. Date: Jan. 31, 2013

(54) LASER DICING METHOD

(71) Applicants: Mitsuhiro IDE, Shizuoka (JP); Makoto HAYASHI, KANAGAWA (JP); Shoichi SATO, Shizuoka (JP)

(72) Inventors: Mitsuhiro IDE, Shizuoka (JP); Makoto HAYASHI, KANAGAWA (JP); Shoichi SATO, Shizuoka (JP)

(21) Appl. No.: 13/556,641

(22) Filed: Jul. 24, 2012

(30) Foreign Application Priority Data
Jul. 27, 2011 (JP) 2011-164041

(51) Int. Cl. B23K 26/36

(52) U.S. Cl. 219/121.72

(57) ABSTRACT

A laser dicing method for a substrate to be processed having a metal film on a surface thereof includes a metal film removing step for placing the substrate to be processed on a stage, irradiating the metal film with a defocused pulse laser beam, and removing the metal film, and a crack forming step for irradiating a region where the metal film is removed of the substrate to be processed with a pulse laser beam, and forming a crack in the substrate to be processed.

### CROSS-REFERENCE TO RELATED APPLICATION

This application is based on and claims priority of Japanese Patent Application (JPA) No. 2011-164041, filed on Jul. 27, 2011, the entire contents of which are incorporated herein by reference.

### FIELD OF THE INVENTION

Embodiments described herein relate generally to a laser dicing method using a pulse laser beam.

### BACKGROUND OF THE INVENTION

A method for dicing a semiconductor substrate using a pulse laser beam is disclosed in JP 3867107B. In the method of JP 3867107B, a crack region is formed inside an object to be processed by optical damage caused by the pulse laser beam. The object to be processed is then cut from the crack region as a starting point.

In the related art, formation of the crack region is controlled with parameters including energy of the pulse laser beam, a spot diameter, relative movement speed between the pulse laser beam and the object to be processed, and the like.

Further, for example, there is a case where a metal film such as a copper film is formed on a surface of a substrate to be processed such as a light emitting diode (LED) having a reflection film. When such a substrate to be processed is diced with a laser, for example, there is a method in which the metal film and a base semiconductor or an insulator substrate are simultaneously subjected to an ablation process. However, the ablation process has a problem of causing scattering and increasing deterioration of brightness of the LED on a cut surface after dicing.

In the case where the substrate to be processed has a metal film, there is another method in which the metal film is removed by other process such as etching, which is provided only for the removal of the metal film, a crack region is then formed inside an object to be processed, and the object to be processed is cut. However, this method may cause a problem of increasing processes for dicing.

### SUMMARY OF THE INVENTION

A laser dicing method for a substrate to be processed, a metal film being provided on a surface of the substrate to be processed, the method including: a metal film removing step for placing the substrate to be processed on a stage, irradiating the metal film with a defocused pulse laser beam, and removing the metal film; and a crack forming step for irradiating a region where the metal film is removed of the substrate to be processed with a pulse laser beam, and forming a crack in the substrate to be processed, the crack forming step including: placing the substrate to be processed on the stage; generating a clock signal; emitting the pulse laser beam synchronized with the clock signal; relatively moving the substrate to be processed and the pulse laser beam; switching, per optical pulse unit, irradiation and non-irradiation of the substrate to be processed with the pulse laser beam by controlling passing and blocking of the pulse laser beam using a pulse picker in synchronization with the clock signal; and forming, in the substrate to be processed, the crack reaching a surface of the substrate by controlling irradiation energy of the pulse laser beam, depth of a processing point of the pulse laser beam, and length of an irradiation region and a non-irradiation region of the pulse laser beam so that the cracks appear on the surface of the substrate to be processed in a continuous manner.

In the method of the above-described aspect, the metal film removing step desirably includes: placing the substrate to be processed on the stage; generating the clock signal; emitting the pulse laser beam synchronized with the clock signal; relatively moving the substrate to be processed and the pulse laser beam; switching, per optical pulse unit, the irradiation and non-irradiation of the substrate to be processed with the pulse laser beam by controlling the passing and blocking of the pulse laser beam using a pulse picker in synchronization with the clock signal; and removing the metal film.

In the method of the above-described aspect, it is desired to form the cracks in the surface of the substrate to be processed in an approximately linear manner.

In the method of the above-described aspect, it is desired to synchronize a position of the substrate to be processed and an operation start position of the pulse picker.

In the method of the above-described aspect, the substrate to be processed is desirably a sapphire substrate, a quartz substrate, or a glass substrate.

In the method of the above-described aspect, it is desirable to relatively move the substrate to be processed and the pulse laser beam by moving the stage in synchronization with the clock signal.

In the method of the above-described aspect, it is desired to execute the metal film removing step and the crack forming step in succession in a state where the substrate to be processed remains on the same stage of the same laser dicing device.

According to the present invention, a laser dicing method can be provided which realizes excellent cutting characteristics with respect to a substrate to be processed having a metal film on a surface thereof by optimizing irradiation condition of a pulse laser beam.

### BRIEF DESCRIPTION OF THE DRAWINGS

FIG. 1 is a schematic block diagram showing an example of a laser dicing device used in a laser dicing method according to an embodiment;

FIG. 2 is a diagram illustrating timing control of the laser dicing method according to the embodiment;

FIG. 3 is a diagram showing timing of pulse picker operation and a modulation pulse laser beam of the laser dicing method according to the embodiment;

FIG. 4 is an illustration of an irradiation pattern of the laser dicing method according to the embodiment;

FIG. 5 is a top view showing an irradiation pattern with which a sapphire substrate is irradiated;

FIG. 6 is an A-A cross-sectional view of FIG. 5;

FIG. 7 is a diagram illustrating a relationship between stage movement and dicing processing;

FIG. 8 is a diagram showing an irradiation pattern of Example 1;

FIGS. 9A to 9E are diagrams showing results of the laser dicing of Examples 1 to 4 and Comparative Example 1;

FIG. 10 is a cross-sectional view showing a result of the laser dicing of Example 1;

FIGS. 11A to 11F are diagrams showing results of the laser dicing of Examples 5 to 10;

FIGS. 12A to 12E are diagrams showing results of the laser dicing of Examples 11 to 15;

FIGS. 13A to 13F are diagrams showing results of the laser dicing of Examples 16 to 21;

FIGS. 14A and 14B are illustrations showing a case in which cracks are formed by scanning the same scanning line of a substrate multiple times with a pulse laser beam having different depths of a processing point;

FIGS. 15A and 15B are optical photographs of cut surfaces cut under conditions of FIGS. 14A and 14B;

FIGS. 16A to 16C are diagrams showing results of the laser dicing of Examples 22 to 24;

FIGS. 17A to 17D are illustrations of operation of the embodiment;

FIGS. 18A and 18B are diagrams showing a result of the laser dicing of Example 25;

FIG. 19 is a diagram showing results of the laser dicing of Examples 26 to 28, and Comparative Examples 2 and 3; and

FIGS. 20A to 20C are diagrams showing effects of a metal film removing step of the laser dicing method of the embodiment.

### DETAILED DESCRIPTION OF THE INVENTION

Hereinafter, an embodiment of the present invention will be described with reference to the appended drawings. Note that, in the specification, “a processing point” means a point in the vicinity of a condensing position (focal point position) of a pulse laser beam inside a substrate to be processed, and also means a point at which the degree of reformation of the substrate to be processed is maximized in the depth direction. Also, “depth of a processing point” means depth of the processing point of the pulse laser beam from a surface of the substrate to be processed.

A laser dicing method of the present embodiment is a laser dicing method for a substrate to be processed which has a metal film such as a copper film on a surface thereof. The method includes a metal film removing step in which the substrate to be processed is placed on a stage, the metal film is irradiated with a defocused pulse laser beam, and the metal film is removed. Further, the method includes a crack forming step in which a region where the metal film is removed of the substrate to be processed is irradiated with a pulse laser beam, and a crack is formed in the substrate to be processed. Further, in the crack forming step, the substrate to be processed is placed on the stage, a clock signal is generated, the pulse laser beam synchronized with the clock signal is emitted, the substrate to be processed and the pulse laser beam are relatively moved, and irradiation and non-irradiation of the substrate to be processed with the pulse laser beam is switched per optical pulse unit by controlling passing and blocking of the pulse laser beam using a pulse picker in synchronization with the clock signal, whereby the crack reaching a surface of the substrate is formed in the substrate to be processed. Here, the cracks are formed so as to appear on the surface of the substrate to be processed in a continuous manner by irradiation energy of the pulse laser beam, depth of a processing point of the pulse laser beam, and length of an irradiation region and a non-irradiation region of the pulse laser beam.

According to the above configuration, a laser dicing method having excellent cutting characteristics can be provided in relation to a substrate to be processed having a metal film formed on a surface thereof. Here, the following points are given as the excellent cutting characteristics: (1) less scattering occurs at dicing including metal film removing, (2) processing is simple, (3) a cut portion can be cut with good linearity, (4) cutting can be done with small force so as to improve yield of a diced element, (5) no deterioration is caused due to influence of a laser emitted at metal film removing or crack forming for an element provided on a substrate, such as an LED element epitaxially formed on the substrate.

Further, forming the cracks in the surface of the substrate to be processed in a continuous manner can facilitate dicing of a hard substrate such as a sapphire substrate. Also, dicing with a narrow dicing width can be realized.

Note that, in the metal film removing step described above, it is desired to place the substrate to be processed on the stage, to generate the clock signal, to emit the pulse laser beam synchronized with the clock signal, to

relatively move the substrate to be processed and the pulse laser beam, to switch, per optical pulse unit, the irradiation and non-irradiation of the substrate to be processed with the pulse laser beam by controlling the passing and blocking of the pulse laser beam using a pulse picker in synchronization with the clock signal, and to remove the metal film. In doing so, removing of the metal film can be carried out in a stable, accurate, and uniform manner.

A laser dicing device according to the present embodiment which realizes the above-described laser dicing method includes a stage on which a substrate to be processed can be placed, a reference clock oscillation circuit for generating a clock signal, a laser oscillator for emitting a pulse laser beam, a laser oscillator controller for synchronizing the pulse laser beam and the clock signal, a pulse picker provided at an optical path between the laser oscillator and the stage, and for switching irradiation/non-irradiation of the substrate to be processed with the pulse laser beam, and a pulse picker controller for controlling, per optical pulse unit, passing/blocking of the pulse laser beam by the pulse picker in synchronization with the clock signal.

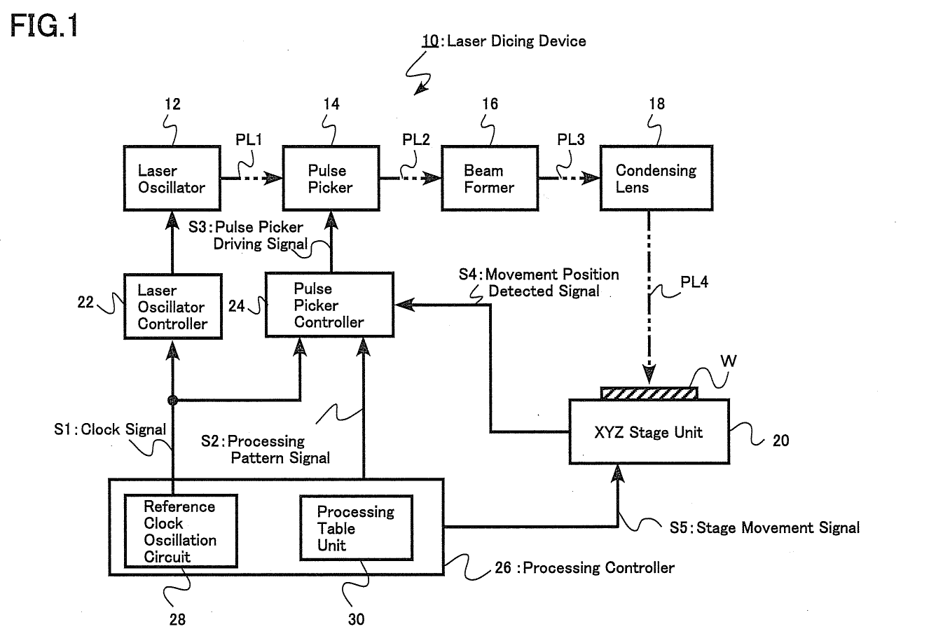

FIG. 1 is a schematic block diagram showing an example of a laser dicing device according to the present embodiment. As shown in FIG. 1, a laser dicing device 10 of the present embodiment includes, as key components, a laser oscillator 12, a pulse picker 14, a beamformer 16, a condensing lens 18, an XYZ stage unit 20, a laser oscillator controller 22, a pulse picker controller 24, and a processing controller 26. In the processing controller 26, a reference clock oscillation circuit 28 for generating a desired clock signal S1 and a processing table unit 30 are provided.

The laser oscillator 12 is configured to emit a pulse laser beam PL1 of a cycle Tc in synchronization with the clock signal S1 generated at the reference clock oscillation circuit 28. The strength of irradiated pulse beam exhibits Gaussian distribution. The clock signal S1 is a clock signal for processing control used for controlling the laser dicing processing.

Here, as a laser emitted from the laser oscillator 12, a laser having a wavelength permeable to the substrate to be processed is used. As the laser, Nd: a YAG laser, Nd: a YVO₄ laser, Nd: a YLF laser, or the like can be used. For example, when the substrate to be processed is a sapphire substrate with a metal film thereon, it is desired to use the laser of Nd: YVO₄ having the wavelength of 532 nm.

The pulse picker 14 is provided to an optical path between the laser oscillator 12 and the condensing lens 18. Further, the pulse picker 14 is configured to switch, per optical pulse unit, the irradiation/non-irradiation of the substrate to be processed with the pulse laser beam PL1 by switching the passing/blocking (ON/OFF) of the pulse laser beam PL1 in synchronization with the clock signal S1. In this way, ON/OFF of the pulse laser beam PL1 is controlled by the operation of the pulse picker 14 for processing the substrate to be processed, whereby the pulse laser beam PL1 becomes a modulated modulation pulse laser beam PL2.

The pulse picker 14 is desirably configured from an acousto-optic modulator (AOM), for example. Alternatively, a Raman diffraction type electro-optic modulator (EOM) can be used.

The beamformer 16 causes the entered pulse laser beam PL2 to become a pulse laser beam PL3 having a desired form. For example, the beamformer 16 may be a beam expander which magnifies the beam diameter at a certain magnification. Alternatively, an optic element such as a homogenizer which uniformizes the distribution of optical strength of a beam cross-section can be provided. Alternatively, an element which causes the beam cross-section to be a circular form or an optical element which causes the beam cross-section to be circular polarized light can be provided.

The condensing lens 18 is configured to condense the pulse laser beam PL3 formed at the beamformer 16, and to irradiate a substrate to be processed W placed on the XYZ stage unit 20 with a pulse laser beam PL4. The substrate to be processed may be, for example, a sapphire substrate having an LED on an under surface thereof.

The XYZ stage unit 20 can place the substrate to be processed W thereon, and includes an XYZ stage (hereinafter, may also be simply referred to as “stage”) freely movable in the XYZ direction, and a driving mechanism unit of the XYZ stage, a position sensor having a laser interferometer, for example, for positioning the stage, and the like. Here, the XYZ stage is configured to have positioning accuracy and movement error with sub-micron accuracy. Further, a focal point of a pulse laser beam can be adjusted with respect to the substrate to be processed W by moving the stage in the direction of Z-axis, whereby the depth of a processing point can be controlled.

The processing controller 26 controls overall processing by the laser dicing device 10. The reference clock oscillation circuit 28 generates the desired clock signal S1. Further, a processing table is stored in the processing table unit 30 in which dicing processing data is written by the number of optical pulses of the pulse laser beam.

Next, a laser dicing method using the above-described laser dicing device 10 will be described with reference to FIGS. 1 to 7.

First, the substrate to be processed W, for example, a sapphire substrate with a copper film thereon is placed on the XYZ stage unit 20. The sapphire substrate is a wafer having a GaN layer epitaxially grown on an under surface of the substrate, and a plurality of LEDs is patterned on the GaN layer. Positioning of the wafer with respect to the XYZ stage is carried out with reference to a notch formed on the wafer or an orientation flat.

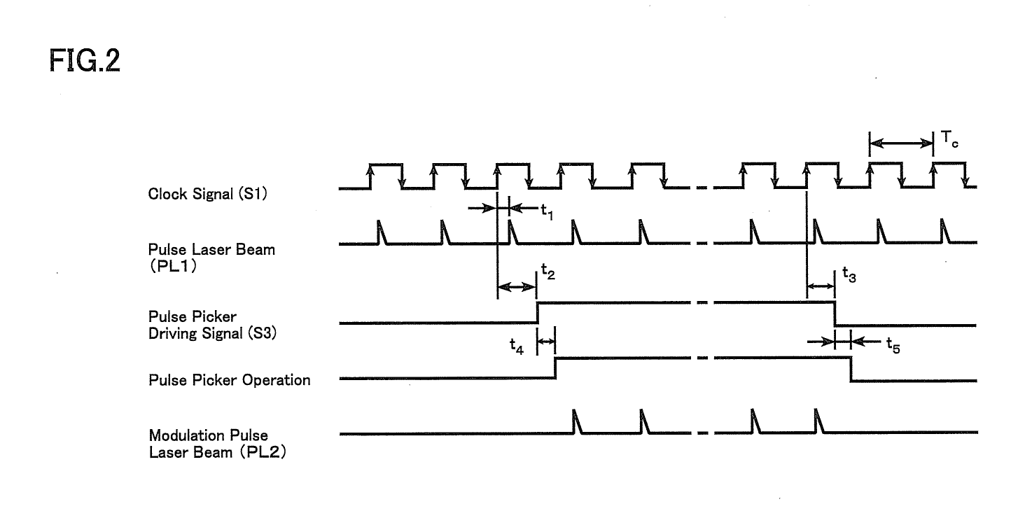

FIG. 2 is a diagram illustrating timing control of the laser dicing method of the present embodiment. The clock signal S1 of the cycle of Tc is generated at the reference clock oscillation circuit 28 in the processing controller 26. The laser oscillator controller 22 controls the laser oscillator 12 to emit the pulse laser beam PL1 of the cycle Tc in synchronization with the clock signal S1. At this time, delay time t1 is caused by rising edges of the clock signal S1 and the pulse laser beam.

As the laser beam, a laser beam having a wavelength permeable to the substrate to be processed is used. At the crack forming step, it is desirable to use a laser beam to be irradiated having larger photon energy hν than a band gap Eg of absorption of the material of the substrate to be processed. When the energy hν is exceedingly larger than the band gap Eg, the absorption of the laser beam is caused. This is called “multiphoton absorption” in which a pulse width of the laser beam is exceedingly shortened so that the multiphoton absorption is caused inside the substrate to be processed. This induces permanent structural transformation such as change of ionic valence, crystallization, non-crystallization, polarization orientation, and minute crack formation without transforming the energy of the multiphoton absorption into thermal energy. Accordingly, a color center is formed.

As the irradiation energy (irradiation power) of the laser beam (pulse laser beam), it is desired to select the most suitable condition for removing a metal film at the metal film removing step, while it is desired to select the most suitable condition for forming continuous cracks in a surface of the substrate to be processed at the crack forming step.

Using a wavelength permeable to the material of the substrate to be processed at the crack forming step enables the laser beam to be guided and condensed in the vicinity of the focal point inside the substrate. Therefore, the color center can be produced in a focal manner. This color center is hereinafter referred to as “reformed region”.

The pulse picker controller 24 refers to a processing pattern signal S2 output from the processing controller 26, and generates a pulse picker driving signal S3 in synchronization with the clock signal S1. The processing pattern signal S2 is stored in the processing table unit 30, and is generated by referring to the processing table in which information of the irradiation patterns is written by the number of optical pulses per optical pulse unit. The pulse picker 14 switches the passing/blocking (ON/OFF) of the pulse laser beam PL1 in synchronization with the clock signal S1 based on the pulse picker driving signal S3.

The modulation pulse laser beam PL2 is generated by the operation of the pulse picker 14. Note that delay times t2 and t3 are caused by the rising edge of the clock signal S1 and the rising edge and the falling edge of the pulse laser beam. Also, delay times t4 and t5 are caused by the rising edge and the falling edge of the pulse laser beam, and the pulse picker operation.

At the processing of the substrate to be processed, timing for generating the pulse picker driving signal S3 and the like, and timing for relative movement between the substrate to be processed and the pulse laser beam are determined in consideration of the delay times t1 to t5.

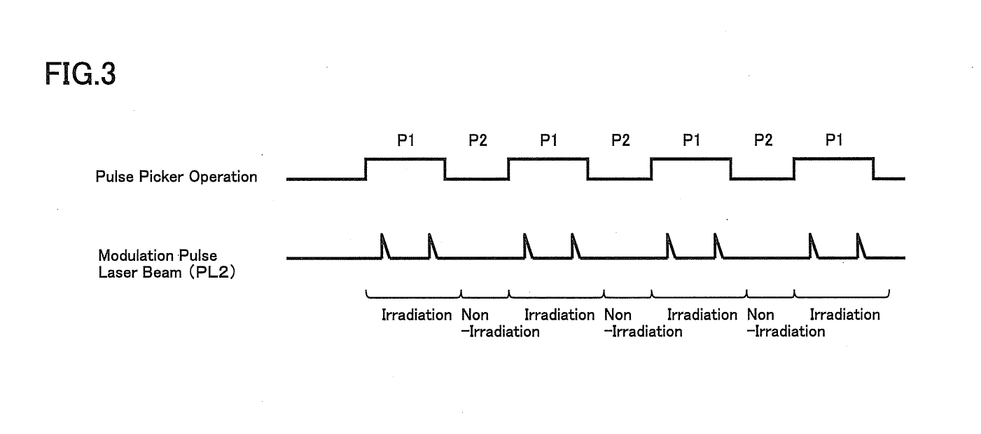

FIG. 3 is a diagram showing timing of the pulse picker operation and the modulation pulse laser beam PL2 of the laser dicing method according to the present embodiment. The pulse picker operation is switched per optical pulse unit in synchronization with the clock signal S1. In this way, the irradiation pattern per optical pulse unit can be realized by synchronizing the oscillation of the pulse laser beam and the pulse picker operation with the same clock signal S1.

To be more specific, the irradiation/non-irradiation with the pulse laser beam is carried out based on a predetermined condition defined by the number of optical pulses. That is, the pulse picker operation is carried out based on the number of irradiation beam pulses (P1) and the number of non-irradiation beam pulses (P2), whereby the irradiation/non-irradiation of the substrate to be processed are switched. The values of P1 and P2 which define the irradiation pattern of the pulse laser beam are, for example, defined in the processing table as irradiation area register setting and non-irradiation area register setting. The values of P1 and P2 are set to be a predetermined condition which optimizes metal film removing at the metal film removing step and crack forming at the crack forming step in consideration of the material of the metal film and the substrate to be processed, condition of the laser beam, and the like.

The modulation pulse laser beam PL2 is formed by the beamformer 16 to be the pulse laser beam PL3 having a desired waveform. Further, the formed pulse laser beam PL3 is condensed by the condensing lens 18 to become the pulse laser beam PL4 having a desired beam diameter, and is emitted to the wafer as the substrate to be processed.

When the wafer is diced in the directions of X-axis and Y-axis, first, the XYZ stage is moved at constant speed in the direction of X-axis, for example, and scanned with the pulse laser beam PL4. Then, after the desired dicing in the direction of X-axis is completed, the XYZ stage is moved at constant speed in the direction of Y-axis and scanned with the pulse laser beam PL4, whereby the dicing in the direction of Y-axis is carried out.

The interval of the irradiation/non-irradiation with the pulse laser beam is controlled based on the number of irradiation beam pulses (P1), the number of non-irradiation beam pulses (P2), and the stage speed.

The direction of Z-axis (height direction) is adjusted in such a way that a condensing position (a focal point position) of the condensing lens is positioned at predetermined depths inside and outside the wafer. The predetermined depths are respectively set in such a way that a metal film can be removed in a desired manner at the metal film removing step and a crack can be formed in the surface of the substrate to be processed in a desired shape at the crack forming step.

At this time, where

Refractive index of the substrate to be processed: n

Processing position from the surface of the substrate to be processed: L

Z-axis movement distance: Lz

the following relationship is obtained:

Lz=L/n

That is, when the condensing position of the condensing lens is processed at the position of depth “L” from the surface of the substrate where the surface of the substrate to be processed is an initial position of the Z-axis, Z-axis can be just moved by “Lz”.

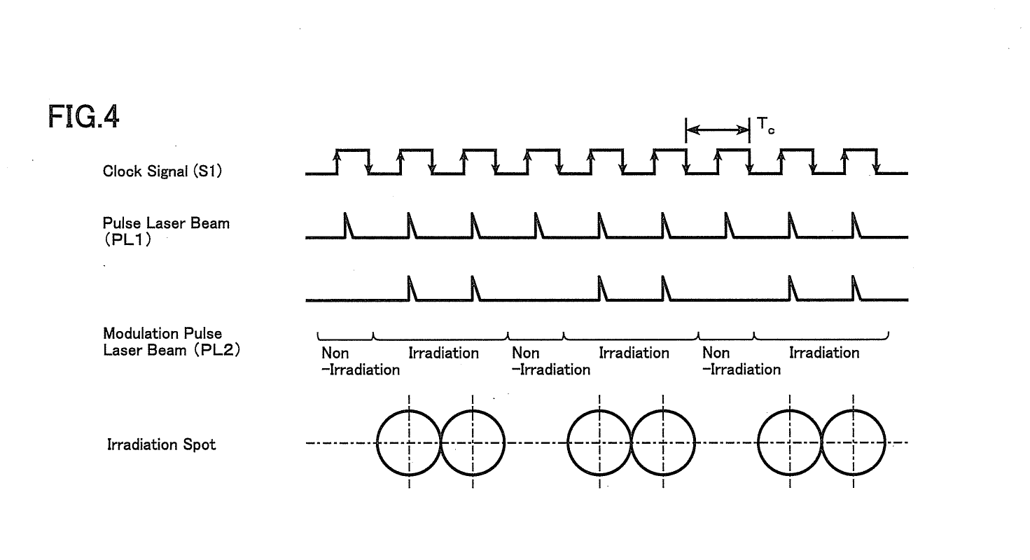

FIG. 4 is an illustration of an irradiation pattern of the laser dicing method according to the present embodiment. As shown in the drawing, the pulse laser beam PL1 is generated in synchronization with the clock signal S1. The modulation pulse laser beam PL2 is then generated by controlling the passing/blocking of the pulse laser beam in synchronization with the clock signal S1.

Then, an irradiation beam pulse of the modulation pulse laser beam PL2 is formed on the wafer as an irradiation spot by the movement of the stage in the lateral direction (in the direction of X-axis or the Y-axis). By generating the modulation pulse laser beam PL2 in this way, the irradiation spot is controlled per optical pulse unit, and the wafer is intermittently irradiated. In the case of FIG. 4, the number of irradiation beam pulses (P1)=2, the number of non-irradiation beam pulses (P2)=1, and a condition is set under which the irradiation/non-irradiation with the irradiation beam pulse (Gaussian beam) is repeated at a pitch of the spot diameter.

Here, when the processing is carried out under the following condition:

Beam spot diameter: D (μm)

Repetition frequency: F (KHz)

a stage movement speed V (m/sec) is obtained as follows:

V=D×10−6×F×103

at which the irradiation/non-irradiation with the irradiation beam pulse is carried out at the pitch of the spot diameter.

For example, when the processing is carried out under the following processing condition:

Beam spot diameter: D=2 μm

Repetition frequency: F=50 KHz

the following value is obtained:

Stage movement speed: V=100 mm/sec

Also, where the power of the irradiation beam is P (Watt), the wafer is irradiated with the optical pulse having irradiation pulse energy per pulse P/F.

Parameters including the irradiation energy of the pulse laser beam (power of irradiation beam), the depth of the processing point of the pulse laser beam, and the interval of the irradiation/non-irradiation with the pulse laser beam are determined in such a way that the metal film can be removed at the metal film removing step and the cracks can be continuously formed in the surface of the substrate to be processed at the crack forming step.

As described above, the laser dicing method according to the present embodiment includes the metal film removing step and the crack forming step. By these two steps, the cracks are formed in the substrate to be processed having a metal film thereon, and the substrate to be processed is cut. At this time, from a viewpoint of simplification of the dicing processing, it is desired to execute the metal film removing step and the crack forming step in succession while the substrate to be processed remains on the same stage of the same laser dicing device.

At the metal film removing step, by using the above-described laser dicing device, the substrate to be processed is placed on the stage, and a metal film such as a copper or gold film is irradiated with a defocused pulse laser beam, and the metal film is removed.

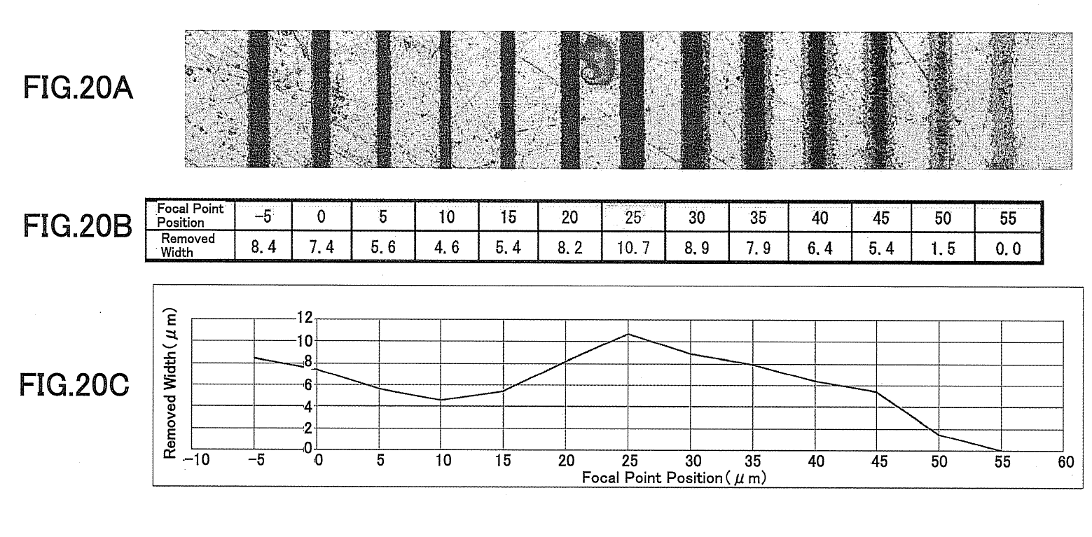

FIGS. 20A to 20C are diagrams showing effects of the metal film removing step of the laser dicing method according to the present embodiment. FIG. 20A is an optical photograph of a top surface of the substrate to be processed after laser irradiation, FIG. 20B is a table showing focal point positions of the pulse laser beam and the removed width of the metal film, and FIG. 20C is a diagram graphically showing FIG. 20B.

The metal film removing shown in FIGS. 20A to 20C is carried out under the following laser processing condition:

Substrate to be processed: a sapphire substrate having a metal film (copper) thereon

Laser beam source: Nd: YVO₄ laser

Wavelength: 532 nm

Irradiation energy: 100 mW

Laser frequency: 100 KHz

The number of irradiation beam pulses (P1): 1

The number of non-irradiation beam pulses (P2): 1

Stage speed: 5 mm/sec

Focal point position: −5 to 55 μm (at 5 μm intervals)

Note that the focal point position takes a negative value in the direction toward the inside of the substrate to be processed and takes a positive value in the direction away from the substrate to be processed where an interface between the metal film and the sapphire base is zero (0).

As is clear from FIGS. 20A to 20C, the metal film is removed especially by irradiating the metal film with the defocused pulse laser beam. In FIGS. 20A to 20C, it can be seen that the metal film is removed most widely by setting the focal point position at 25 μm from the interface between the metal film and the sapphire in the direction away from the sapphire.

In the present embodiment, only the metal film can be removed while damage to the base substrate is minimized by using the difference in energy absorption between the metal film and the base substrate such as sapphire.

From a viewpoint of avoiding the damage to the base substrate due to the focal point position of the pulse laser beam coming to the base substrate, it is desired to defocus in such a way that the focal point position comes outside the substrate to be processed.

After the metal film is removed, a region of the substrate to be processed where the metal film has been removed is irradiated with the pulse laser beam, and the crack forming step is carried out for forming a crack in the substrate to be processed.

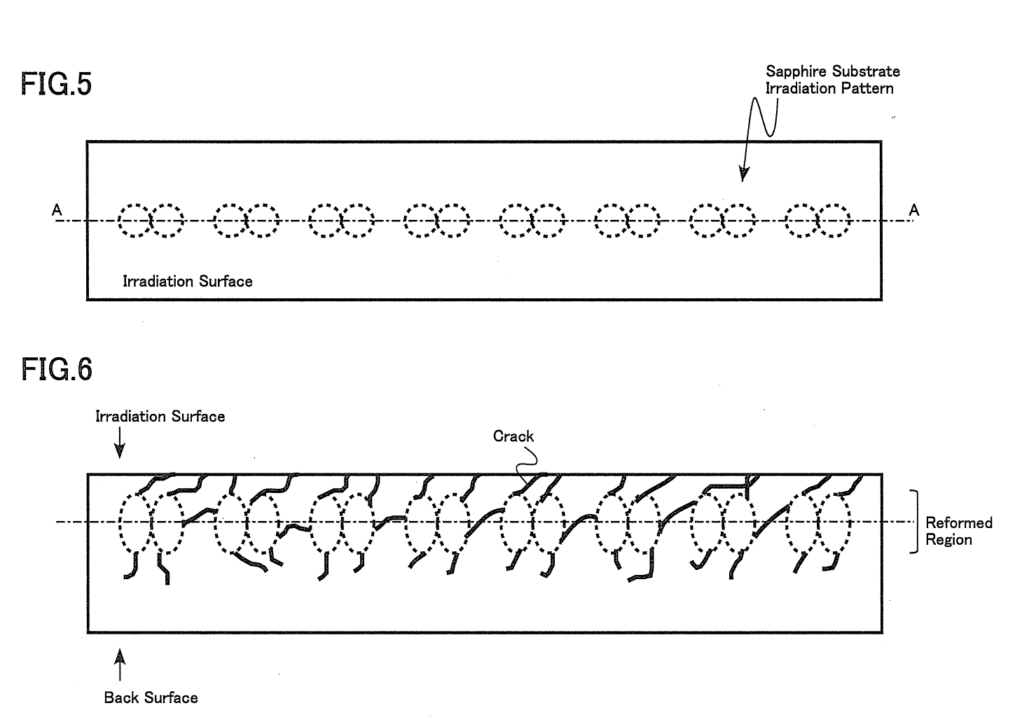

FIG. 5 is a top view showing an irradiation pattern with which the sapphire substrate is irradiated at the crack forming step. When seen from above the irradiation surface, the irradiation spot is formed at the pitch of the irradiation spot diameter under the condition of the number of irradiation beam pulses (P1)=1 and the number of non-irradiation beam pulses (P2)=2. FIG. 6 is an A-A cross-sectional view of FIG. 5. As shown in the drawing, a reformed region is formed inside the sapphire substrate. A crack (or a ditch) which reaches the surface of the substrate from the reformed region is then formed along the scanning line of the optical pulse. The cracks are then continuously formed in the surface of the substrate to be processed. Note that, in the present embodiment, the crack is formed so as to be exposed only on the side of the surface of the substrate and not to reach the back side of the substrate.

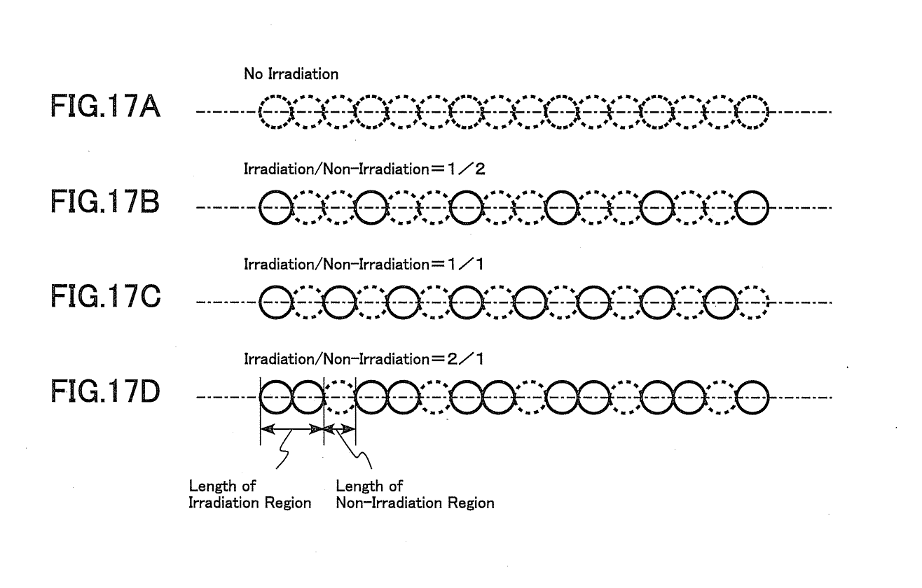

FIGS. 17A to 17D are illustrations of operation of the present embodiment. For example, positions which can be irradiated with the pulse laser are shown in FIG. 17A by the dotted line circles in a case where the pulse laser is irradiated at the maximum possible frequency of the pulse laser beam and at the maximum possible stage speed. FIG. 17B is the irradiation pattern in a case of the irradiation/non-irradiation=½. The solid line circles show irradiation positions and the dotted line circles show non-irradiation positions.

Here, assume that shortening the interval between the irradiation spots (the length of the non-irradiation region) results in the better cutting characteristic. This is possible as shown in FIG. 17C by causing the irradiation/non-irradiation=1/1 without changing the stage speed. Suppose that the pulse picker is not used unlike the present embodiment, it is necessary to lower the stage speed in order to realize a similar condition, and this leads to a problem of lowering the throughput of the dicing processing.

Here, assume that lengthening the length of the irradiation region by the continuous irradiation spots results in the better cutting characteristic. This is possible as shown in FIG. 17D by causing the irradiation/non-irradiation=2/1 without changing the stage speed. Suppose that the pulse picker is not used unlike the preset embodiment, it is necessary to lower the stage speed and to change the stage speed in order to realize a similar condition, and this leads to a problem of lowering the throughput of the dicing processing as well as having extreme difficulty in controlling.

Alternatively, when the pulse picker is not used, it can be considered to obtain a similar condition to FIG. 17D by raising the irradiation energy with the irradiation pattern of FIG. 17B. However, in this case, since the laser power centered on one point becomes large, increasing of the crack width and deterioration of linearity of the cracks are concerned. Further, in a case where a substrate to be processed such as a sapphire substrate having an LED element formed thereon is processed, there is another concern that the laser which reaches an LED region at the opposite side of the cracks is increased, whereby the LED element may be deteriorated.

As described above, according to the present embodiment, various cutting conditions can be realized without changing the conditions of the pulse laser beam or the stage speed, whereby the most suitable cutting condition can be found out without deteriorating productivity and element characteristics.

Note that, in the present specification, “length of irradiation region” and “length of non-irradiation region” mean the lengths shown in FIG. 17D.

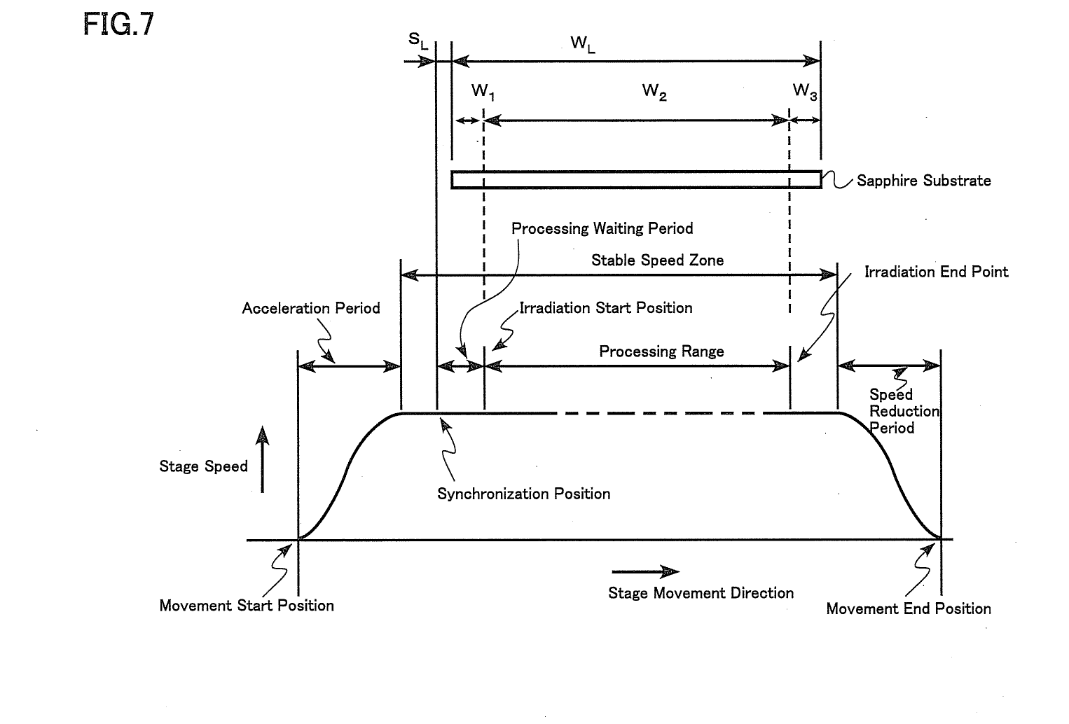

FIG. 7 is a diagram illustrating a relationship between the stage movement and the dicing processing. A position sensor for detecting movement positions in the directions of the X-axis and Y-axis is provided to the XYZ state. For example, a position at which the stage speed enters a stable speed zone after the movement starts in the direction of the X-axis or Y-axis is set as a synchronization position in advance. When the synchronization position is detected by the position sensor, for example, the pulse picker operation is allowed by a movement position detected signal S4 (FIG. 1) being transmitted to the pulse picker controller 24, and the pulse picker is operated by the pulse picker driving signal S3. It may be configured to detect an edge face of the substrate to be processed by the position sensor by setting the synchronization position to be the edge face of the substrate to be processed.

As described above, the following values are managed:

S_{L}: distance from the synchronization position to the substrate

W_{L}: processing length

W₁: distance from a substrate edge to an irradiation start position

W₂: processing range

W₃: distance from an irradiation end position to the substrate edge

Accordingly, a stage position and a position of the substrate to be processed placed on the stage are synchronized with an operation start position of the pulse picker. That is, the irradiation/non-irradiation with the pulse laser beam and the stage position are synchronized. Therefore, it is secured that the stage moves at constant speed (the stage is in the stable speed zone) at the irradiation/non-irradiation with the pulse laser beam. Accordingly, regularity of the irradiation spot position is secured, whereby stable crack formation can be realized.

Here, when a thick substrate is processed, it can be considered to improve the cutting characteristic by scanning the same scanning line of the substrate multiple times (multiple layers) with the pulse laser beam having different depths of the processing point to form a crack. In such a case, the pulse irradiation position at the scanning of different depths can be controlled in an accurate and arbitrary manner by synchronizing the stage position and the operation start position of the pulse picker, whereby optimization of the dicing condition becomes possible.

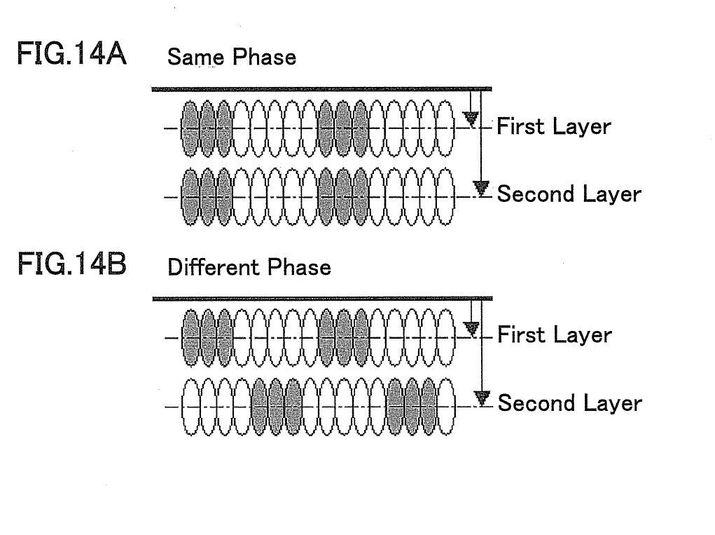

FIGS. 14A and 14B are illustrations of a case where cracks are formed by scanning the same scanning line of the substrate multiple times with the pulse laser beam having different depths of the processing point, and are schematic diagrams of the irradiation patterns at a cross-section of the substrate. “ON” (colored) represents an irradiation region, and “OFF” (white) represents a non-irradiation region. FIG. 14A shows a case where a first layer and a second layer of the scanning of the irradiation are the same phase, that is, the upper and lower relationship of the irradiation pulse positions between the first layer and the second layer has uniformity. FIG. 14B shows a case where the first layer and the second layer of the scanning of the irradiation are different phases, that is, the upper and lower relationship of the irradiation pulse positions between the first layer and the second layer lacks in uniformity.

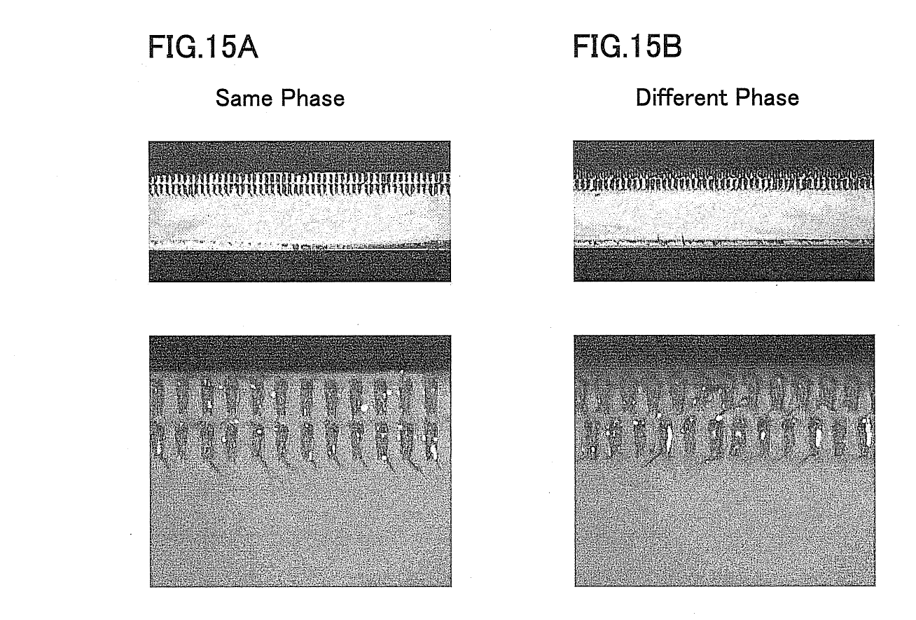

FIGS. 15A and 15B are optical photographs of cut surfaces cut under the conditions of FIGS. 14A and 14B. FIG. 15A shows the case of the same phase, and FIG. 15B shows the case of the different phases. The upper photographs are photographs at a low magnification, whereas the lower photographs are photographs at a high magnification, respectively. In this way, the relationship between the first and second layers of the scanning of the irradiation can be accurately controlled by synchronizing the stage position and the operation start position of the pulse picker.

Note that the substrate to be processed shown in FIGS. 15A and 15B is a sapphire substrate having the thickness of 150 μm. In this case, cutting force required for cutting is 0.31 N for the case of the same phase, 0.38 N for the case of the different phases, and the case of the same phase has a superior cutting characteristic.

Note that, here, an example has been shown in which the numbers of pulses of the irradiation/non-irradiation for the first and second layers are the same. However, a most suitable condition can be found out by setting the different numbers of pulses of the irradiation/non-irradiation for the first and second layers.

Further, it is desired, for example, to synchronize the movement of the stage with the clock signal in order to further improve accuracy of the irradiation spot position. This becomes possible, for example, by synchronizing a stage movement signal S5 (FIG. 1) transmitted from the processing controller 26 to the XYZ stage unit 20 with the clock signal S1.

As the laser dicing method according to the present embodiment, subsequent cutting of the substrate becomes easy by forming the cracks reaching the surface of the substrate and appearing on the surface of the substrate to be processed in a continuous manner. For example, even when the substrate is a hard substrate such as the sapphire substrate, the cutting becomes easy by applying artificial force to the crack which reaches the surface of the substrate as a starting point of the cutting or division, whereby the superior cutting characteristic can be realized. Accordingly, productivity of the dicing can be improved.

In the previous method of continuously irradiating the substrate with the pulse laser beam at the crack forming step, it is difficult to control a desired shape of the cracks which are continuously formed in the surface of the substrate even if the stage movement speed, the number of apertures of the condensing lens, the power of irradiation beam, and the like are optimized. As described in the present embodiment, generation of the cracks which reach the surface of the substrate can be controlled by optimizing the irradiation pattern by intermittently switching the irradiation/non-irradiation with the pulse laser beam per optical pulse unit, whereby the laser dicing method having the superior cutting characteristic can be realized.

That is, for example, narrow cracks along the scanning line of the laser can be formed in the surface of the substrate in an approximately linear and continuous manner. The influence of the cracks on the devices such as the LED formed on the substrate can be minimized by forming such cracks in the approximately linear and continuous manner. Further, since the linear cracks can be formed, the width of a region on the surface of the substrate where the cracks are formed can be narrowed. Thus, the dicing width of design can be narrowed. Therefore, the number of chips of the devices formed on the wafer or on the same substrate can be increased, and this contributes to reduction of manufacturing cost of the devices.

The embodiment of the present invention has been described with reference to the concrete examples. However, the present invention is not limited to the concrete examples. In the embodiment, parts of the laser dicing method, the laser dicing device, and the like which are not directly relevant to the description of the present invention have been omitted. However, relevant elements in relation to the laser dicing method, laser dicing device, and the like can be properly selected and used.

In addition, all laser dicing methods that include the elements of the present invention and can be properly altered by those skilled in the art fall within the scope of the invention. The scope of the invention is defined by the appended claims or the equivalents thereof.

For example, in the embodiment, a sapphire substrate on which an LED is formed has been exemplarily described as the substrate to be processed. The present invention is useful for the substrate like the sapphire substrate which is hard, lacks in cleavage, and is difficult to cut. However, the substrate to be processed can be a semiconductor material substrate such as SiC (silicon carbide) substrate, a piezoelectric material substrate, a quartz substrate, and a glass substrate such as quartz glass.

Further, in the embodiment, a case has been exemplarily described in which the substrate to be processed and the pulse laser beam are relatively moved by moving the stage. However, for example, a method of relatively moving the substrate to be processed and the pulse laser beam by scanning with the pulse laser beam using the laser beam scanner and the like can be adopted.

Further, in the embodiment, a case has been exemplarily described in which the number of irradiation beam pulses (P1)=2, and the number of non-irradiation beam pulses (P2)=1, any values can be taken for the values of P1 and P2 for the most suitable condition. Further, in the embodiment, a case has been exemplarily explained in which the irradiation/non-irradiation with the irradiation beam pulse is repeated at the pitch of the spot diameter. However, the most suitable condition can be found out by changing the pulse frequency or the stage movement speed to change the pitch of the irradiation/non-irradiation. For example, the pitch of the irradiation/non-irradiation can be made 1/n times or n times as large as the spot diameter.

Especially, in a case where the substrate to be processed is the sapphire substrate, the irradiation energy is set to be 30 mW or more and 150 mW or less, and the passing of the pulse laser beam is set to be 1 to 4 optical pulse unit(s), and the blocking of the pulse laser beam is set to be 1 to 4 optical pulse unit(s) so that the interval of irradiation is 1 to 6 μm, whereby satisfactory cracks having good linearity and continuity can be formed in the surface of the substrate to be processed.

Further, as for the patterns of the dicing processing, for example, various dicing processing patterns can be available by providing a plurality of irradiation region registers and non-irradiation region registers, or by changing the values of the irradiation region resister or the non-irradiation region register to be desired values at desired time in real time.

Further, as the laser dicing device, a device has been exemplarily described which includes a processing table unit for storing a processing table in which the dicing processing data is written by the number of optical pulses of the pulse laser beam. However, such a processing table unit is not necessarily provided in the device as long as the device is configured to control the passing/blocking of the pulse laser beam by the pulse picker per optical pulse unit.

To further improve the cutting characteristic, a melt process or an ablation process can be further applied to the surface by irradiating with the laser after the continuous cracks are formed in the surface of the substrate.

### EXAMPLES

Hereinafter, examples in relation to the crack forming step of the present invention will be described.

### Example 1

According to the method described in the embodiment, the laser dicing was carried out under the following condition:

Substrate to be processed: a sapphire substrate, the thickness of the substrate 100 μm

Laser beam source: Nd: YVO₄ laser

Wavelength: 532 nm

Irradiation energy: 50 mW

Laser frequency: 20 KHz

The number of irradiation beam pulses (P1): 1

The number of non-irradiation beam pulses (P2): 2

Stage speed: 25 mm/sec

Depth of a processing point: about 25.2 μm from a surface of the substrate to be processed

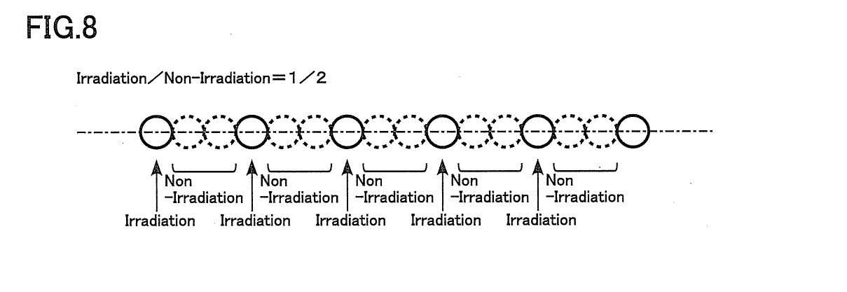

FIG. 8 is a diagram showing an irradiation pattern of Example 1. As shown in the drawing, after the optical pulse is irradiated once, non-irradiation comes with two optical pulse units. This condition is hereinafter described as “irradiation/non-irradiation=½”. Note that, here the pitch of the irradiation/no-irradiation is equal to the spot diameter.

In the case of Example 1, the spot diameter was about 1.2 μm. Therefore, the interval of irradiation was about 3.6 μm.

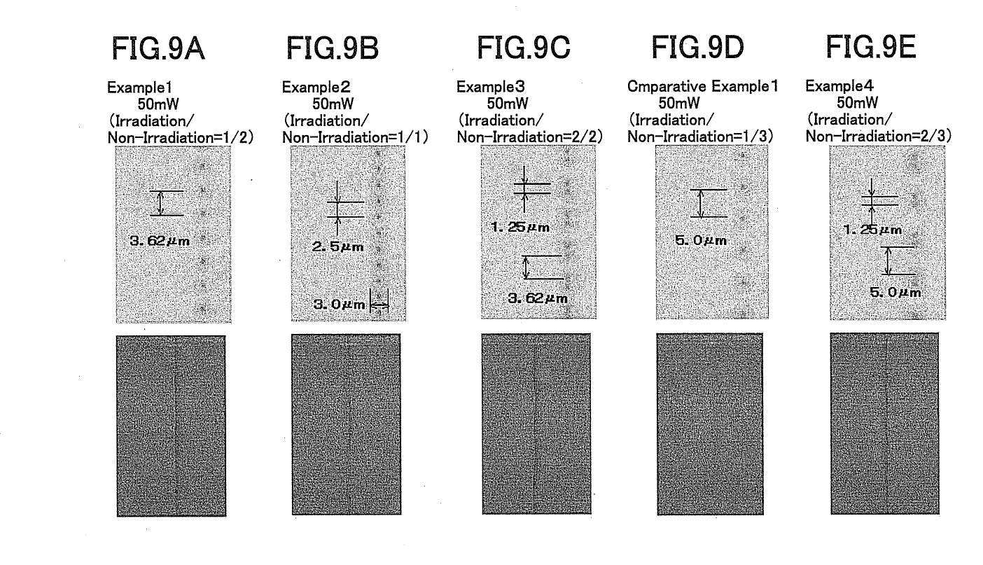

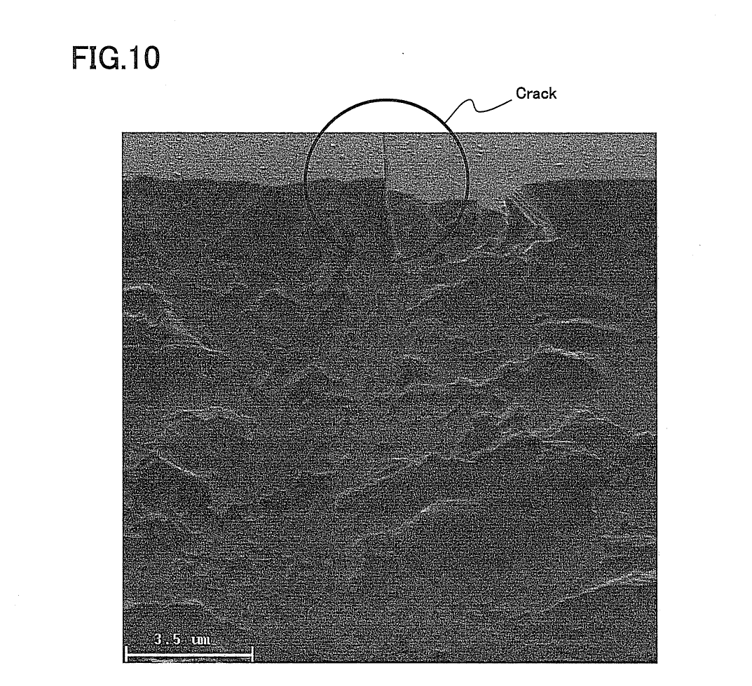

A result of the laser dicing is shown in FIG. 9A. The upper photograph is an optical photograph of a top surface of the substrate, and the lower photograph is an optical photograph of the top surface of the substrate at a lower magnification than the upper photograph. The upper optical photograph is shot by adjusting the focal point to the reformed region in the substrate. The lower optical photograph is shot by adjusting the focal point to the crack on the surface of the substrate. Also, FIG. 10 is a SEM photograph of a cross-section of the substrate perpendicular to the direction of the crack.

The substrate to be processed was a strip form having the width of about 5 mm, and the strip form was irradiated with the pulse laser beam in the direction of extension to form the crack. After the crack was formed, the cutting force required for cutting using a breaker was evaluated.

### Example 2

The laser dicing was carried out by a similar method to Example 1 except for the irradiation/non-irradiation=1/1. A result of the laser dicing is shown in FIG. 9B. The upper photograph is an optical photograph of the top surface of the substrate, and the lower photograph is an optical photograph of the top surface of the substrate at a lower magnification than the upper photograph.

### Example 3

The laser dicing was carried out by a similar method to Example 1 except for the irradiation/non-irradiation=2/2. A result of the laser dicing is shown in FIG. 9C. The upper photograph is an optical photograph of the top surface of the substrate, and the lower photograph is an optical photograph of the top surface of the substrate at a lower magnification than the upper photograph.

### Example 4

The laser dicing was carried out by a similar method to Example 1 except for the irradiation/non-irradiation=⅔. A result of the laser dicing is shown in FIG. 9E. The upper photograph is an optical photograph of the top surface of the substrate, and the lower photograph is an optical photograph of the top surface of the substrate at a lower magnification than the upper photograph.

### Comparative Example 1

The laser dicing was carried out by a similar method to Example 1 except for the irradiation/non-irradiation=⅓. A result of the laser dicing is shown in FIG. 9D. The upper photograph is an optical photograph of the top surface of the substrate, and the lower photograph is an optical photograph of the top surface of the substrate at a lower magnification than the upper photograph.

In Examples 1 to 4, continuous cracks were able to be formed in the surface of the substrate to be processed as shown in FIGS. 9A to 9C, 9E and 10 by setting the irradiation energy of the pulse laser beam, the depth of the processing point, and the interval of the irradiation/non-irradiation to be the condition described above.

Especially, under the condition of Example 1, extremely linear cracks were formed in the surface of the substrate to be processed. Therefore, the linearity of the cut portion after cutting was excellent. Further, the condition of Example 1 allowed the substrate to be cut with the smallest cutting force. Therefore, in the case where the substrate to be processed is the sapphire substrate, it is desired, considering controllability of each condition, to set the irradiation energy to be 50±5 mW, the depth of the processing point to be 25.0±2.5 μm, the passing of the pulse laser beam to be one optical pulse unit, and the blocking of the pulse laser beam to be two optical pulse units so that the interval of the irradiation be 3.6±0.4 μm.

Meanwhile, as shown in Example 3, when the reformed regions were close and the cracks were formed inside the substrate between the reformed regions, there was a tendency that the cracks on the surface wound, and a region where the cracks were generated grew wider. This happens because the power of the laser beam centered on the narrow region is too large.

In Comparative Example 1, the condition was not optimized, and continuous cracks were not formed in the surface of the substrate. Therefore, the evaluation of the cutting force was not possible.

### Example 5

According to the method described in the embodiment, the laser dicing was carried out under the following condition:

Substrate to be processed: a sapphire substrate, the thickness of the substrate 100 μm

Laser beam source: Nd: YVO₄ laser

Wavelength: 532 nm

Irradiation energy: 90 mW

Laser frequency: 20 KHz

The number of irradiation beam pulses (P1): 1

The number of non-irradiation beam pulses (P2): 1

Stage speed: 25 mm/sec

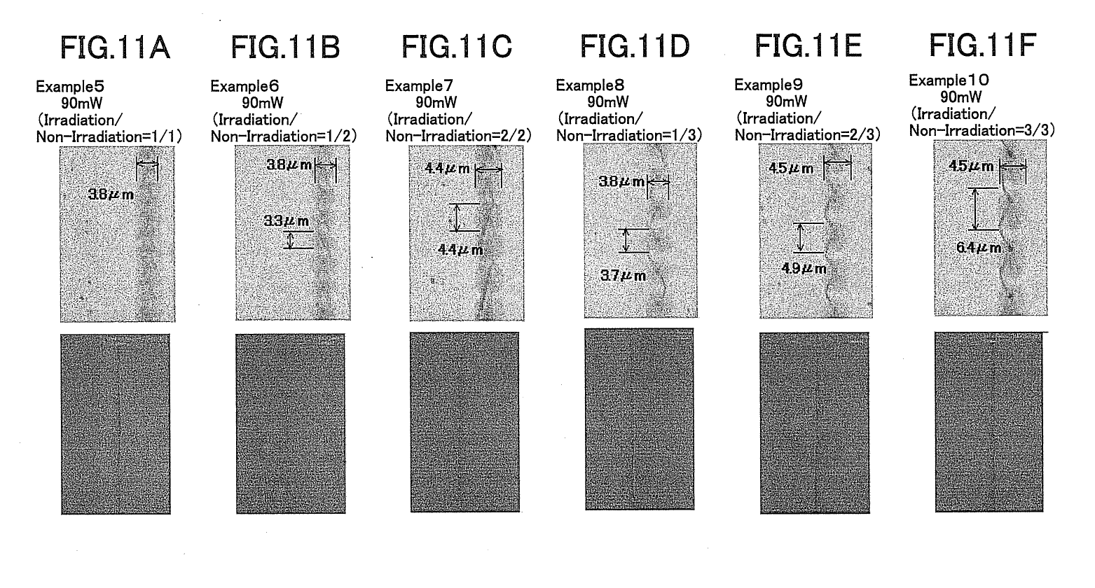

A result of the laser dicing is shown in FIG. 11A. The upper photograph is an optical photograph of the top surface of the substrate, and the lower photograph is an optical photograph of the top surface of the substrate at a lower magnification than the upper photograph. The upper optical photograph is shot by adjusting the focal point to the reformed region in the substrate. The lower optical photograph is shot by adjusting the focal point to the crack on the surface of the substrate.

### Example 6

The laser dicing was carried out by a similar method to Example 5 except for the irradiation/non-Irradiation=½. A result of the laser dicing is shown in FIG. 11B. The upper photograph is an optical photograph of the top surface of the substrate, and the lower photograph is an optical photograph of the top surface of the substrate at a lower magnification than the upper photograph.

### Example 7

The laser dicing was carried out by a similar method to Example 5 except for the irradiation/non-irradiation=2/2. A result of the laser dicing is shown in FIG. 11C. The upper photograph is an optical photograph of the top surface of the substrate, and the lower photograph is an optical photograph of the top surface of the substrate at a lower magnification than the upper photograph.

### Example 8

The laser dicing was carried out by a similar method to Example 5 except for the irradiation/non-irradiation=⅓. A result of the laser dicing is shown in FIG. 11D. The upper photograph is an optical photograph of the top surface of the substrate, and the lower photograph is an optical photograph of the top surface of the substrate at a lower magnification than the upper photograph.

### Example 9

The laser dicing was carried out by a similar method to Example 5 except for the irradiation/non-irradiation=⅔. A result of the laser dicing is shown in FIG. 11E. The upper photograph is an optical photograph of the top surface of the substrate, and the lower photograph is an optical photograph of the top surface of the substrate at a lower magnification than the upper photograph.

### Example 10

The laser dicing was carried out by a similar method to Example 5 except for the irradiation/non-irradiation=⅔. A result of the laser dicing is shown in FIG. 11F. The upper photograph is an optical photograph of the top surface of the substrate, and the lower photograph is an optical photograph of the top surface of the substrate at a lower magnification than the upper photograph.

In Examples 5 to 10, continuous cracks were able to be formed in the surface of the substrate to be processed as shown in FIGS. 11A to 11E by setting the irradiation energy of the pulse laser beam, the depth of the processing point, and the interval of the irradiation/non-irradiation to be the condition described above.

Especially, under the condition of Example 8, relatively linear cracks were formed in the surface of the substrate to be processed. Further, the condition of Example 8 allowed the substrate to be cut with small cutting force. However, compared to Examples 1 to 4 where the irradiation energy is 50 mW, there was a tendency that the cracks on the surface wound and the region where the cracks were generated grew wider. Therefore, the case of 50 mW had superior linearity of the cut portion. This happens because in the case of 90 mW, the power of the laser beam centered on the narrow region is too large compared to the case of 50 mW.

### Example 11

According to the method described in the embodiment, the laser dicing was carried out under the following condition:

Substrate to be processed: a sapphire substrate, the thickness of the substrate 100 μm

Laser beam source: Nd: YVO₄ laser

Wavelength: 532 nm

Irradiation energy: 50 mW

Laser frequency: 20 KHz

The number of irradiation beam pulses (P1): 1

The number of non-irradiation beam pulses (P2): 2

Stage speed: 25 mm/sec

Depth of a processing point: about 15.2 μm from a surface of the substrate to be processed

The dicing processing was carried out under a condition in which the depth of the processing point is shallower by 10 μm than Example 1, that is, the condensing position of the pulse laser beam is closer to the surface of the substrate to be processed than Example 1.

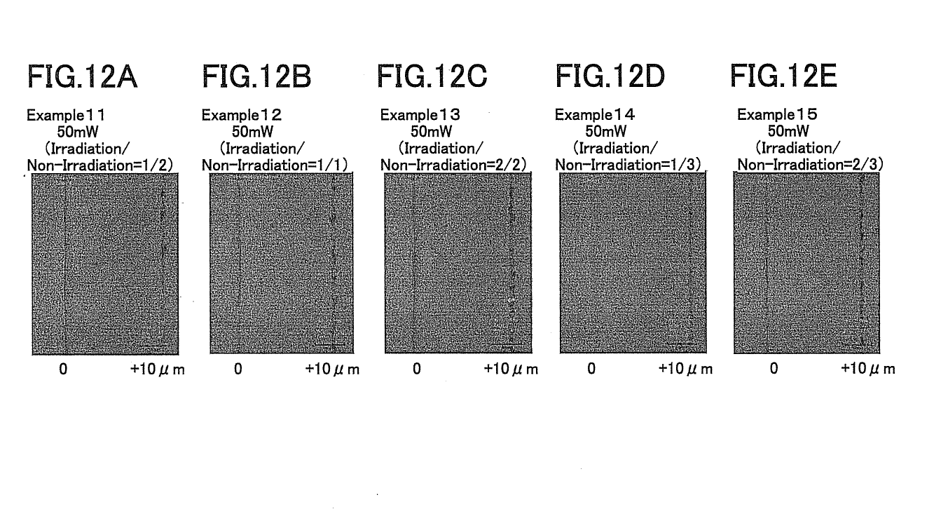

A result of the laser dicing is shown in FIG. 12A. The photograph is shot by adjusting the focal point to the reformed region in the substrate. In the photograph, the line at the right side (+10 μm) results from the condition of Example 11. The condition of Example 1 (0) having difference only in the depth of the processing point is shown at the left side for comparison.

### Example 12

The laser dicing was carried out by a similar method to Example 11 except for the irradiation/non-irradiation=1/1. A result of the laser dicing is shown in FIG. 12B.

### Example 13

The laser dicing was carried out by a similar method to Example 11 except for the irradiation/non-irradiation=2/2. A result of the laser dicing is shown in FIG. 12C.

### Example 14

The laser dicing was carried out by a similar method to Example 11 except for the irradiation/non-irradiation=⅓. A result of the laser dicing is shown in FIG. 12D.

### Example 15

The laser dicing was carried out by a similar method to Example 11 except for the irradiation/non-irradiation=⅔. A result of the laser dicing is shown in FIG. 12E.

In Examples 11 to 15, continuous cracks were able to be formed in the surface of the substrate to be processed as shown in FIGS. 12A to 12E by setting the irradiation energy of the pulse laser beam, the depth of the processing point, and the interval of the irradiation/non-irradiation to be the condition described above.

However, compared to Examples 1 to 4, a large crack of the reformed region was exposed on the surface. Also, there was a tendency that the cracks on the surface wound, and the region where the cracks were generated grew wider.

### Example 16

According to the method described in the embodiment, the laser dicing was carried out under the following condition:

Substrate to be processed: a sapphire substrate

Laser beam source: Nd: YVO₄ laser

Wavelength: 532 nm

Irradiation energy: 90 mW

Laser frequency: 20 KHz

The number of irradiation beam pulses (P1): 1

The number of non-irradiation beam pulses (P2): 1

Stage speed: 25 mm/sec

The dicing processing was carried out under a condition in which the depth of the processing point is shallower by 10 μm than Example 5, that is, the condensing position of the pulse laser beam is closer to the surface of the substrate to be processed than Example 5.

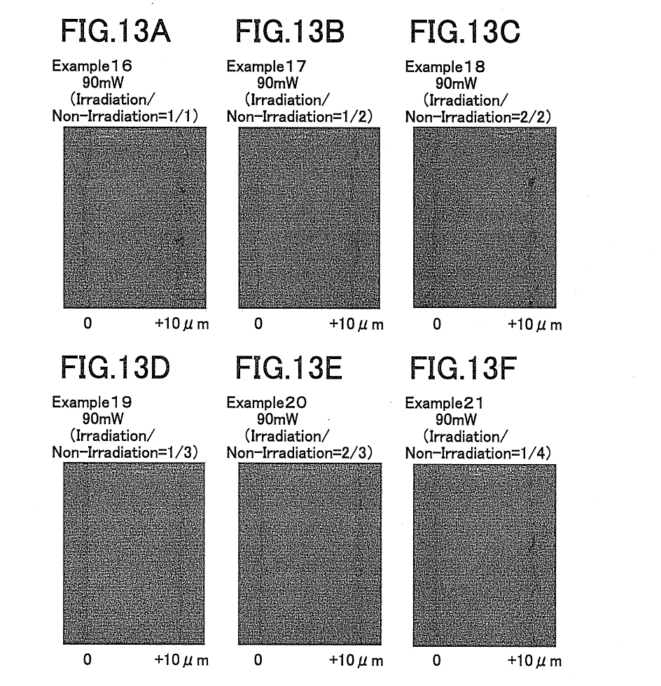

A result of the laser dicing is shown in FIG. 13A. The photograph is shot by adjusting the focal point to the reformed region in the substrate. In the photograph, the line at the right side (+10 μm) results from the condition of Example 16. The condition of Example 5 (0) having difference only in the depth of the processing point is shown at the left side for comparison.

### Example 17

The laser dicing was carried out by a similar method to Example 16 except for the irradiation/non-irradiation=½. A result of the laser dicing is shown in FIG. 13B.

### Example 18

The laser dicing was carried out by a similar method to Example 16 except for the irradiation/non-irradiation=2/2. A result of the laser dicing is shown in FIG. 13C.

### Example 19

The laser dicing was carried out by a similar method to Example 16 except for the irradiation/non-irradiation=⅓. A result of the laser dicing is shown in FIG. 13D.

### Example 20

The laser dicing was carried out by a similar method to Example 16 except for the irradiation/non-irradiation=⅔. A result of the laser dicing is shown in FIG. 13E.

### Example 21

The laser dicing was carried out by a similar method to Example 16 except for the irradiation/non-irradiation=¼. A result of the laser dicing is shown in FIG. 13F.

In Examples 16 to 21, continuous cracks were able to be formed in the surface of the substrate to be processed as shown in FIGS. 13A to 13F by setting the irradiation energy of the pulse laser beam, the depth of the processing point, and the interval of the irradiation/non-irradiation to be the condition described above.

However, compared to Examples 5 to 10, a large crack of the reformed region was exposed on the surface. Also, there was a tendency that the cracks on the surface wound, and the region where the cracks were generated grew wider. Therefore, winding was seen at a cut portion after cutting.

As described above, according to the evaluation of Examples 1 to 21 and Comparative Example 1, it became clear that the linearity of the cracks is excellent and thus the linearity of the cut portion is excellent, whereby the condition of Example 1 with the small cutting force is the most suitable condition when the thickness of the substrate to be processed is 100 μm.

### Example 22

According to the method described in the embodiment, the laser dicing was carried out under the following condition:

Substrate to be processed: a sapphire substrate, the thickness of the substrate 150 μm

Laser beam source: Nd: YVO₄ laser

Wavelength: 532 nm

Irradiation energy: 200 mW

Laser frequency: 200 KHz

The number of irradiation beam pulses (P1): 1

The number of non-irradiation beam pulses (P2): 2

Stage speed: 5 mm/sec

Depth of a processing point: about 23.4 μm from a surface of the substrate to be processed

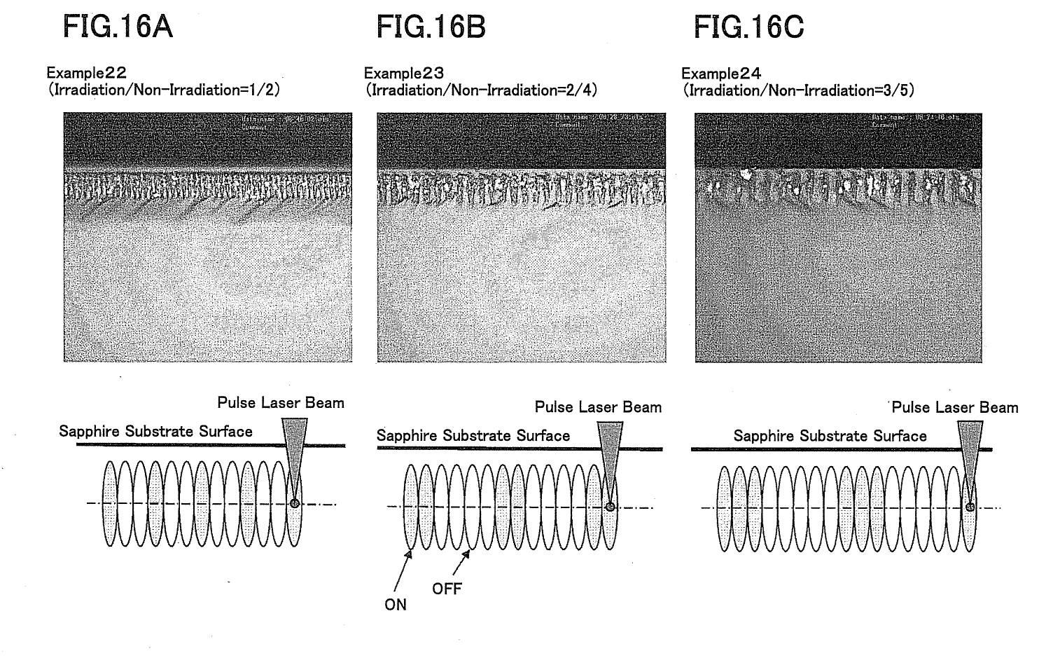

While Examples 1 to 21 used the sapphire substrate having the thickness of 100 μm, the present example uses the sapphire substrate having the thickness of 150 μm. A result of the laser dicing is shown in FIG. 16A. The upper photograph is an optical photograph of the cut surface of the substrate, and the lower diagram is a schematic diagram of the irradiation pattern at a cross-section of the substrate. “ON” (colored) represents the irradiation region, and “OFF” (white) represents the non-irradiation region.

The substrate to be processed was a strip form having the width of about 5 mm, and the strip form was irradiated with the pulse laser beam in the direction of extension to form a crack. After the crack was formed, the cutting force required for cutting using a breaker was evaluated.

### Example 23

The laser dicing was carried out by a similar method to Example 22 except for the irradiation/non-irradiation= 2/4. A result of the laser dicing is shown in FIG. 16B.

### Example 24

The laser dicing was carried out by a similar method to Example 22 except for the irradiation/non-irradiation=⅗. A result of the laser dicing is shown in FIG. 16C.

The linearity of the cracks was at the same level as Examples 22 and 23, and the linearity of the cut portion after cutting was also similar. Further, the cutting force required for cutting in Example 22 was 2.39 to 2.51 N, 2.13 to 2.80 N in Example 23, and 1.09 to 1.51 N in Example 24. As a result of this fact, it was found out that the cutting force required for cutting is the smallest under the condition of Example 24 where the irradiation/non-irradiation=⅗. Therefore, when the thickness of the substrate to be processed is 150 μm, it became clear that the condition of Example 24 is the most suitable.

As described above, according to the examples, it became clear that the most suitable cutting characteristic can be realized even if the thickness of the substrate to be processed is changed by the method in which, in addition to the irradiation energy of the pulse laser beam, the depth of the processing point of the pulse laser beam, and the like, the irradiation/non-irradiation with the pulse laser beam is switched per optical pulse unit by controlling and synchronizing with the clock signal for processing control, which is the same as the one that the pulse laser beam is synchronized with.

Note that, in the examples, cases in which the thickness of the substrate to be processed are 100 and 150 μm have been exemplarily described. However, a substrate to be processed having larger thickness such as 200 or 250 μm can also be used for realizing the most suitable cutting characteristic.

### Example 25

According to the method described in the embodiment, the laser dicing was carried out under the following condition:

Substrate to be processed: a quartz substrate, the thickness of the substrate 100 μm

Laser beam source: Nd: YVO₄ laser

Wavelength: 532 nm

Irradiation energy: 250 mW

Laser frequency: 100 KHz

The number of irradiation beam pulses (P1): 3

The number of non-irradiation beam pulses (P2): 3

Stage speed: 5 mm/sec

Depth of a processing point: about 10 μm from a surface of the substrate to be processed

The substrate to be processed was a strip form having the width of about 5 mm, and the strip form was irradiated with the pulse laser beam in the direction of extension to form a crack. After the crack was formed, the substrate was cut by a breaker.

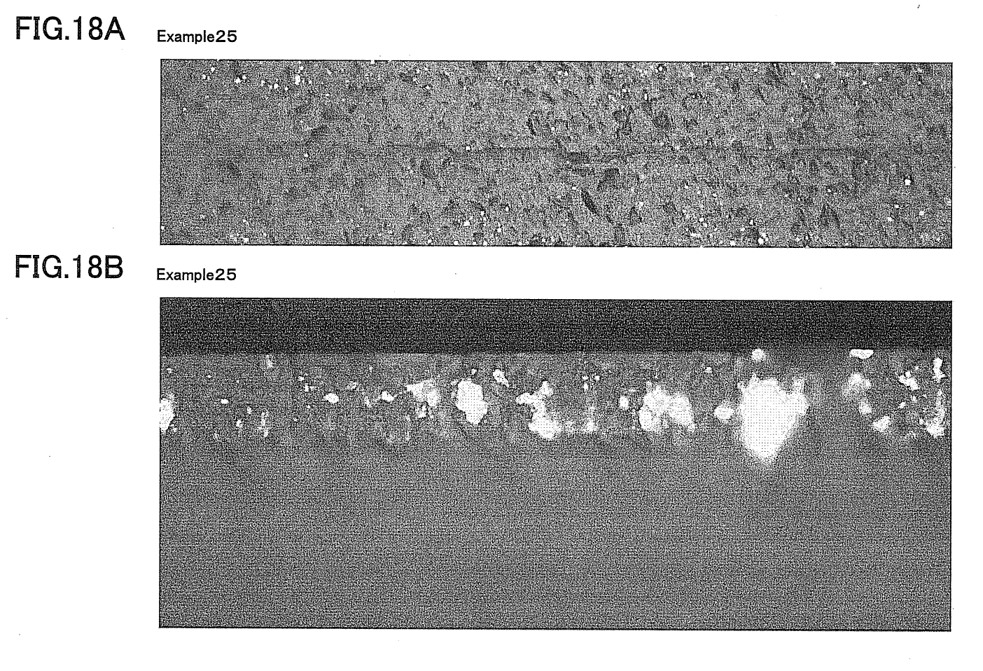

A result of the laser dicing is shown in FIGS. 18A and 18B. FIG. 18A is an optical photograph of the top surface of the substrate, and FIG. 18B is an optical photograph of the cross-section of the substrate. As shown in FIGS. 18A and 18B, even if the substrate to be processed is replaced with the quartz substrate, a reformed region was formed inside the substrate, and continuous cracks were able to be formed in the surface of the substrate to be processed. Therefore, linear cutting by the breaker was possible.

### Example 26

According to the method described in the embodiment, the laser dicing was carried out under the following condition:

Substrate to be processed: a quartz substrate, the thickness of the substrate 500 μm

Laser beam source: Nd: YVO₄ laser

Wavelength: 532 nm

Irradiation energy: 150 mW

Laser frequency: 100 KHz

The number of irradiation beam pulses (P1): 3.

The number of non-irradiation beam pulses (P2): 3

Stage speed: 5 mm/sec

Depth of a processing point: about 12 μm from a surface of the substrate to be processed

The substrate to be processed was a strip form having the width of about 5 mm, and the strip form was irradiated with the pulse laser beam in the direction of extension to form a crack. After the crack was formed, the substrate was cut by a breaker.

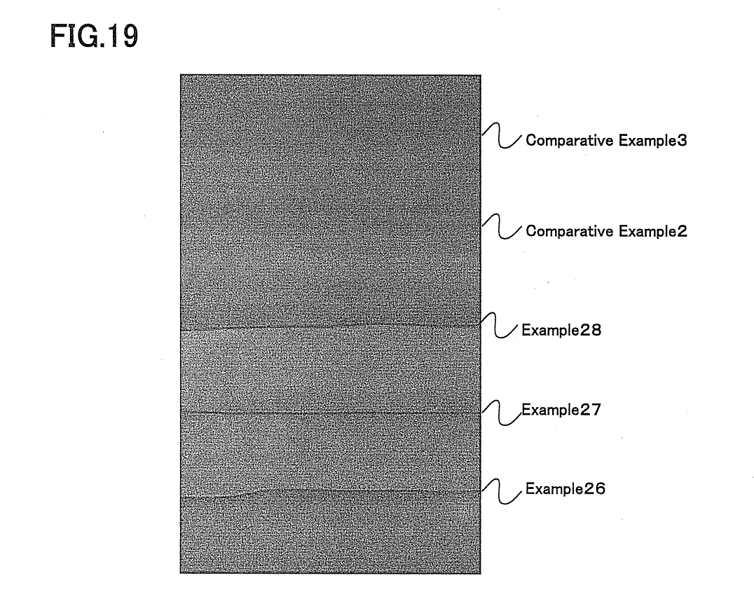

A result of the laser dicing is shown in FIG. 19. FIG. 19 is an optical photograph of the top surface of the substrate.

### Example 27

The laser dicing was carried out by a similar method to Example 26 except that the depth of the processing point is about 14 μm from the surface of the substrate to be processed. A result of the laser dicing is shown in FIG. 19.

### Example 28

The laser dicing was carried out by a similar method to Example 26 except that the depth of the processing point is about 16 μm from the surface of the substrate to be processed. A result of the laser dicing is shown in FIG. 19.

### Comparative Example 2

The laser dicing was carried out by a similar method to Example 26 except that the depth of the processing point is about 18 μm from the surface of the substrate to be processed. A result of the laser dicing is shown in FIG. 19.

### Comparative Example 3

The laser dicing was carried out by a similar method to Example 26 except that the depth of the processing point is about 20 μm from the surface of the substrate to be processed. A result of the laser dicing is shown in FIG. 19.

As shown in FIG. 19, even when the substrate to be processed is replaced with the quartz substrate, continuous cracks were able to be formed in the surface of the substrate to be processed under the conditions of Examples 26 to 28. Therefore, linear cutting by the breaker was possible. Especially, in Example 27, the cracks having the most excellent linearity were formed, whereby the cutting with high linearity was possible. In Comparative Examples 2 and 3, the condition was not optimized, and continuous cracks were not formed in the surface of the substrate.

As described above, according to Examples 25 to 28, it became clear that the most suitable cutting characteristic can be realized even when the substrate to be processed is changed from the sapphire substrate to the quartz substrate or the glass substrate by the method in which, in addition to the irradiation energy of the pulse laser beam, the depth of the processing point of the pulse laser beam, and the like, the irradiation/non-irradiation with the pulse laser beam is switched per optical pulse unit by controlling and synchronizing with the clock signal for processing control, which is the same as the one that the pulse laser beam is synchronized with.

What is claimed is:

1. A laser dicing method for a substrate to be processed, a metal film being provided on a surface of the substrate to be processed, the method comprising:
a metal film removing step for placing the substrate to be processed on a stage, irradiating the metal film with a defocused pulse laser beam, and removing the metal film; and
a crack forming step for irradiating a region where the metal film is removed of the substrate to be processed with a pulse laser beam, and forming a crack in the substrate to be processed,
wherein the crack forming step includes:
placing the substrate to be processed on the stage;
generating a clock signal;
emitting the pulse laser beam synchronized with the clock signal;
relatively moving the substrate to be processed and the pulse laser beam;
switching, per optical pulse unit, irradiation and non-irradiation of the substrate to be processed with the pulse laser beam by controlling passing and blocking of the pulse laser beam using a pulse picker in synchronization with the clock signal; and
forming, in the substrate to be processed, the crack reaching a surface of the substrate by controlling irradiation energy of the pulse laser beam, depth of a processing point of the pulse laser beam, and length of an irradiation region and a non-irradiation region of the pulse laser beam so that the cracks appear on the surface of the substrate to be processed in a continuous manner.

2. The laser dicing method according to claim 1, wherein the metal film removing step includes:
placing the substrate to be processed on the stage;
generating the clock signal;
emitting the pulse laser beam synchronized with the clock signal;
relatively moving the substrate to be processed and the pulse laser beam;
switching, per optical pulse unit, the irradiation and non-irradiation of the substrate to be processed with the pulse laser beam by controlling the passing and blocking of the pulse laser beam using a pulse picker in synchronization with the clock signal; and
removing the metal film.

3. The laser dicing method according to claim 1, wherein the cracks are formed in the surface of the substrate to be processed in an approximately linear manner.

4. The laser dicing method according to claim 1, wherein a position of the substrate to be processed and an operation start position of the pulse picker are synchronized.

5. The laser dicing method according to claim 1, wherein the substrate to be processed is a sapphire substrate, a quartz substrate, or a glass substrate.

6. The laser dicing method according to claim 4, wherein the substrate to be processed and the pulse laser beam are relatively moved by moving the stage in synchronization with the clock signal.

7. The laser dicing method according to claim 1, wherein the metal film removing step and the crack forming step are executed in succession in a state where the substrate to be processed remains on the same stage of the same laser dicing device.

8. The laser dicing method according to claim 1, wherein the metal film is copper or gold.

9. The laser dicing method according to claim 1, wherein the defocus is executed by setting a focal point position of the pulse laser beam from an interface between the metal film and the substrate to be processed in the direction away from the substrate to be processed.

10. The laser dicing method according to claim 9, wherein the focal point position is separated from the interface between the metal film and the substrate to be processed by 20 μm or more when the position of the interface is 0 (zero).
